(19) United States
(12) Patent Application Publication
(10) Pub. No.: US 2002/0077894 A1
(43) Pub. Date: Jun. 20, 2002

(54) Assigning a digital marketing instrument to a user in a computer network

(76) Inventors: David Ottow, San Diego, CA (US); Gianpaolo Carraro, Geneve (CH); Emmanuel Pigout, Magagnosc (FR)

Correspondence Address: STAAS & HALSEY LLP, 700 11TH STREET, NW, SUITE 500, WASHINGTON, DC, 20001, US

(21) Appl. No.: 09/739,341

(22) Filed: Dec. 19, 2000

(51) Int. Cl. G06F 17/60

(52) U.S. Cl. 705/14

(57) ABSTRACT

A method for assigning a digital marketing instrument to a user in a computer network, said computer network comprising a managing server accessing an assignment database and a client communicating with said managing server, said digital marketing instrument originally not being assigned to said user in said assignment database, comprises the steps of displaying a representation of said digital marketing instrument at said client, recording the assignment of said digital marketing instrument to said user in said assignment database, and updating the displayed representation of said digital marketing instrument to reflect the new assignment status of said digital marketing instrument A digital marketing instrument and an apparatus comprise corresponding features. The invention provides a framework that offers an attractive way of obtaining digital marketing instruments and that in particular supports community-driven marketing schemes.

### FIELD OF THE INVENTION

The present invention concerns the fields of electronic marketing and electronic commerce. A particular field of the present invention is that of creating a technical framework for assigning and representing a digital marketing instrument to a user in a computer network.

### BACKGROUND OF THE INVENTION

Traditional marketing has developed several kinds of marketing instruments. Well known examples are coupons that offer some incentive for buying a product and collectibles that incite the customer to repeatedly buy products of the same brand.

Electronic systems are known that mirror traditional rebate and gift coupons. U.S. Pat. No. 5,761,648 discloses a marketing network in which electronic certificates are issued to individual users. U.S. Pat. No. 6,035,280 discloses a virtual coupon system in which customer data is gathered in the process of authorizing a coupon.

These known coupon systems address individual consumers. Obtaining a coupon is a rather administrative process that tends to have little attractiveness with respect to providing an interesting or perhaps even exciting “shopping experience” for the customer.

Furthermore, individual targeting of coupons may not be the most effective marketing concept. Modern marketing research shows that community-driven marketing has significant advantages. Instead of contacting customers individually, community-driven marketing attempts to create consumer networks where interested people can talk and market to each other. This concept is not supported by the above-mentioned coupon systems since, once a coupon has been issued to a specific user, ownership of the coupon cannot be transferred to other users in a community.

WO 98/47091 discloses a virtual property system in which the concepts of property ownership and property transfer are implemented in connection with limited edition, digital objects. The system uses cryptographically signed data structures to allow offline transfer of ownership.

In the context of marketing systems, the feature of making offline transfer of ownership possible renders the overall system more complex and reduces the possibilities for gathering behavioral consumer data.

### OBJECTS AND SUMMARY OF THE INVENTION

It is therefore an object of the present invention to avoid the above-identified problems at least in part. A particular object of the present invention is to provide a system in which the acquisition of digital marketing instruments is an attractive experience for the users. A further object in preferred embodiments of the invention is to provide a framework that supports community-driven marketing schemes. Still a further object in preferred embodiments of the invention is to provide a system that makes it possible for user communities to participate in a “treasure hunt” for digital marketing instruments. Yet a further object in preferred embodiments of the invention is to maximize the possibilities of obtaining data about the behavior and interests of the individual users.

The present invention comprises a method for assigning a digital marketing instrument to a user in a computer network, said computer network comprising a managing server accessing an assignment database and a client communicating with said managing server, said digital marketing instrument originally not being assigned to said user in said assignment database, said method comprising the steps of displaying a representation of said digital marketing instrument at said client, recording the assignment of said digital marketing instrument to said user in said assignment database, and updating the displayed representation of said digital marketing instrument to reflect the new assignment status of said digital marketing instrument. The present invention further comprises a digital marketing instrument and an apparatus having corresponding features. The dependent claims recite preferred embodiments of the invention.

The invention is based on the idea to implement an interactive acquisition process in which feedback about the current acquisition status is provided to the users. This feedback greatly increases attractiveness of the overall process and also incites user participation and emotional user involvement. Thus the effect of a marketing campaign can be increased by taking advantage of the possibilities provided by the present invention.

The term “digital marketing instrument” (which will in the following be abbreviated to “DMI”) is to be understood in its broadest sense as any means that may be employed for marketing purposes and/or for creating or supporting user communities. An example of a DMI would be a coupon that offers some benefit (e.g., a rebate or a gift or a chance of winning some price) if a product is purchased. Another example is a DMI that has some aesthetic or collector's value like a trading card. This also makes it possible, in some embodiments of the invention, to use DMIs for playing online games.

According to the present invention, an assignment of the DMI to a user is recorded in an assignment database. This assignment preferably denotes an ownership relation. For creating an ownership relation between a DMI and a user, an identifier of the DMI is preferably associated with a user identifier in the assignment database. In preferred embodiments, the DMI identifier at least specifies the family of the DMI, and it may or may not include further information. A family of the DMI is typically the information that the DMI belongs to a particular marketer and has a particular set of representations. However, the DMI identifier may also be a unique identifier that characterizes the DMI uniquely in the sense that no other DMI with the same identifier exists.

The assignment of the DMI may take place in connection with the original (first) distribution of a DMI to a user. When the DMI is used in a marketing campaign, the user will normally not have to pay anything for acquiring the DMI. There may, however, be preconditions that must be met by the user. For example, the user may be required to fill out a questionnaire, or a user profile must match certain requirements, or there may be an element of luck involved in finding the DMI and/or in successfully acquiring it. It is also contemplated to use DMIs in online games, and in this context the user might be required to pay for acquiring a set of DMIs (similarly to traditional trading cards). Preferred embodiments of the invention further provide the possibility that ownership of a DMI is transferred from one user to another user. This may happen if the DMI is involved in an exchange process between users or if the DMI is sold or given away for free. All the possibilities mentioned in this paragraph are examples where DMIs are assigned to users

The present invention is not limited to providing feedback only to the user who acquires a DMI. In fact, preferred embodiments of the invention comprise the feature that the change of the assignment status of a DMI is represented not only to the acquiring user, but also to at least one further user. The further user might also have an interest in getting the DMI, and the feedback will inform him or her that the DMI has just been “snatched away”. This feature greatly supports the possibilities for creating and supporting user communities since it introduces an element of competition into the acquiring process. For example, several users may join in a “treasure hunt” and may, in this process, be incited to visit a plurality of Internet pages that show the product range to be marketed.

In preferred embodiments, each DMI is associated with representation data for displaying a suitable representation of the DMI to the user. Preferably this representation is adapted not only to the current assignment status of the DMI, but also to the technical features of the respective client. Thus one and the same DMI may be represented in different ways at clients having different technical capabilities. Possible representation formats include animated presentations, video sequences, pictures, plain text or audio clips.

Preferred embodiments of the invention employ a user interface, which is provided by a client side program, for displaying and updating the representation of the DMI. The user interface program may be written in any language that matches the capabilities of the client. For example, an Internet browser of the client may provide interpretation facilities for user interface programs written in the language Java™ or as a Macromedia™ Flash™ script.

Preferably the client and the managing server communicate with each other via a protocol that uses a request/reply mechanism like, for example, HTTP (hypertext transfer protocol). Since, in these protocols, the managing server typically cannot initiate a communication process to the client without first receiving a request, the client preferably initiates status checks without user interaction. In particular, the client (or the user interface running thereon) may periodically send a status check request message to the managing server. Each request message may comprise an identifier that uniquely represents the user interface. In some embodiments of the invention, an access script is first sent from the managing server to the client, and the user interface code is transmitted to the client thereafter.

Preferred embodiments of the digital marketing instrument also comprise one or more of the features described above and/or in the dependent method claims. Likewise, preferred embodiments of the apparatus comprise one or more of these features.

### DETAILED DESCRIPTION OF THE INVENTION

Further features, objects and advantages of the present invention will be apparent from the following detailed description of sample embodiments. These sample embodiments cover the aspects of acquiring/representing DMIs and trading DMIs. The present invention, however, mainly concerns the aspect of acquiring and representing DMIs, and the trading aspect is just described to provide some additional background information about the system. Reference is made to the schematic drawings, in which:

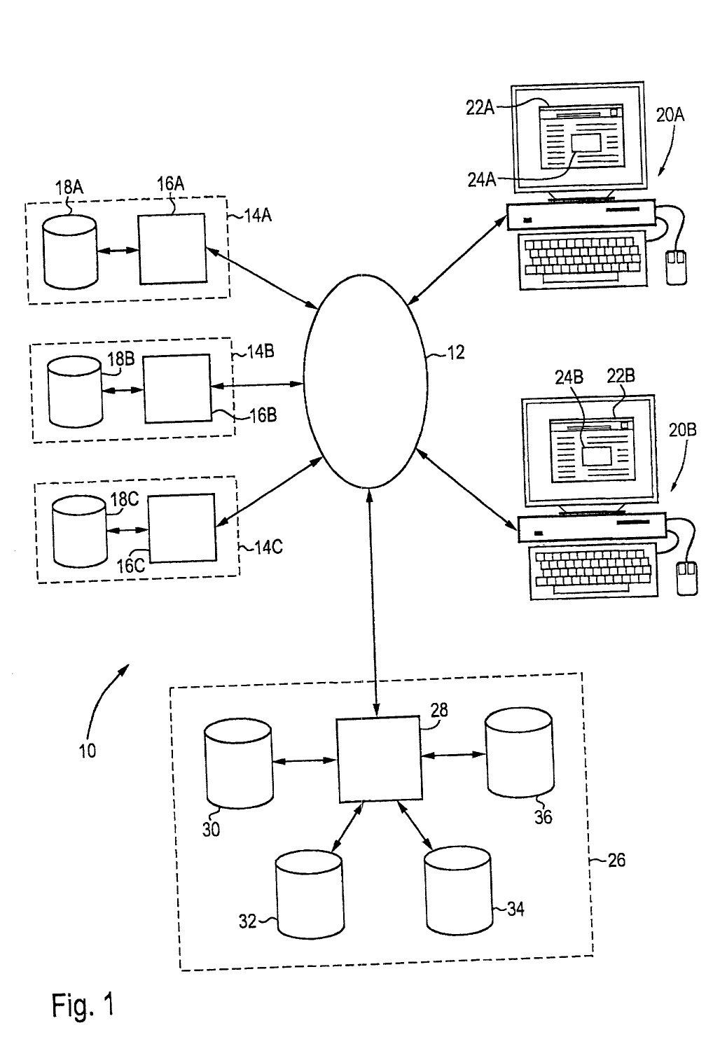

FIG. 1 shows a schematic diagram of the computer network in which the present sample embodiment is implemented,

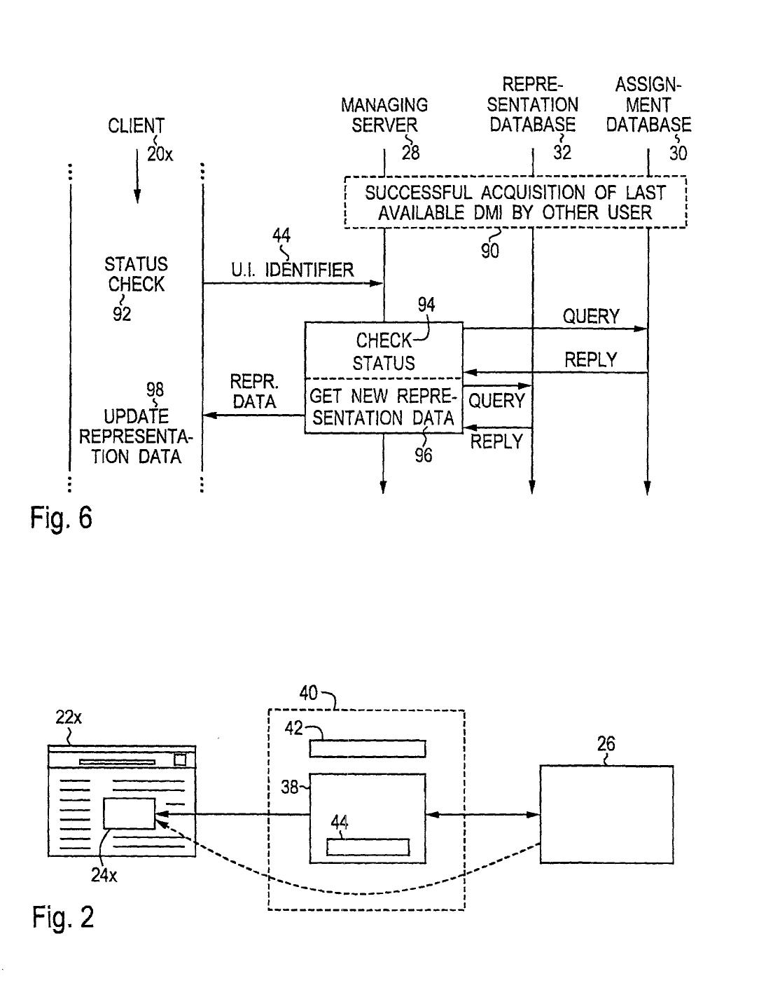

FIG. 2 depicts an example of a digital marketing instrument according to the present sample embodiment and its interaction which other entities of the computer network,

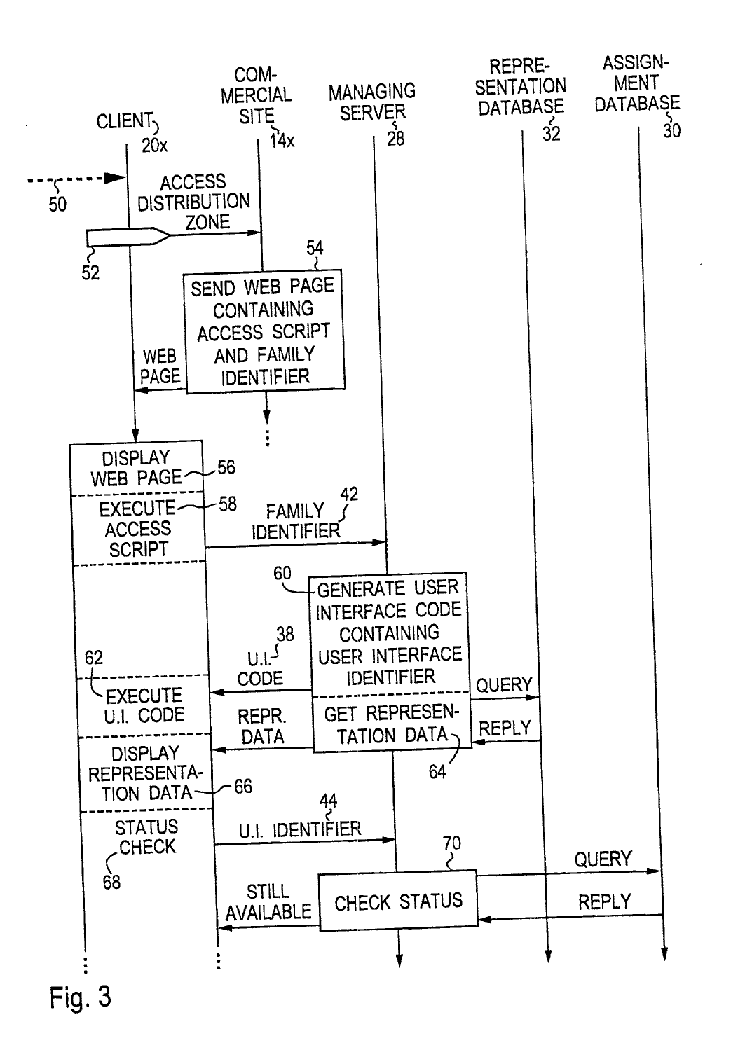

FIG. 3 shows a sample execution sequence in which the availability of the digital marketing instrument is shown to a user,

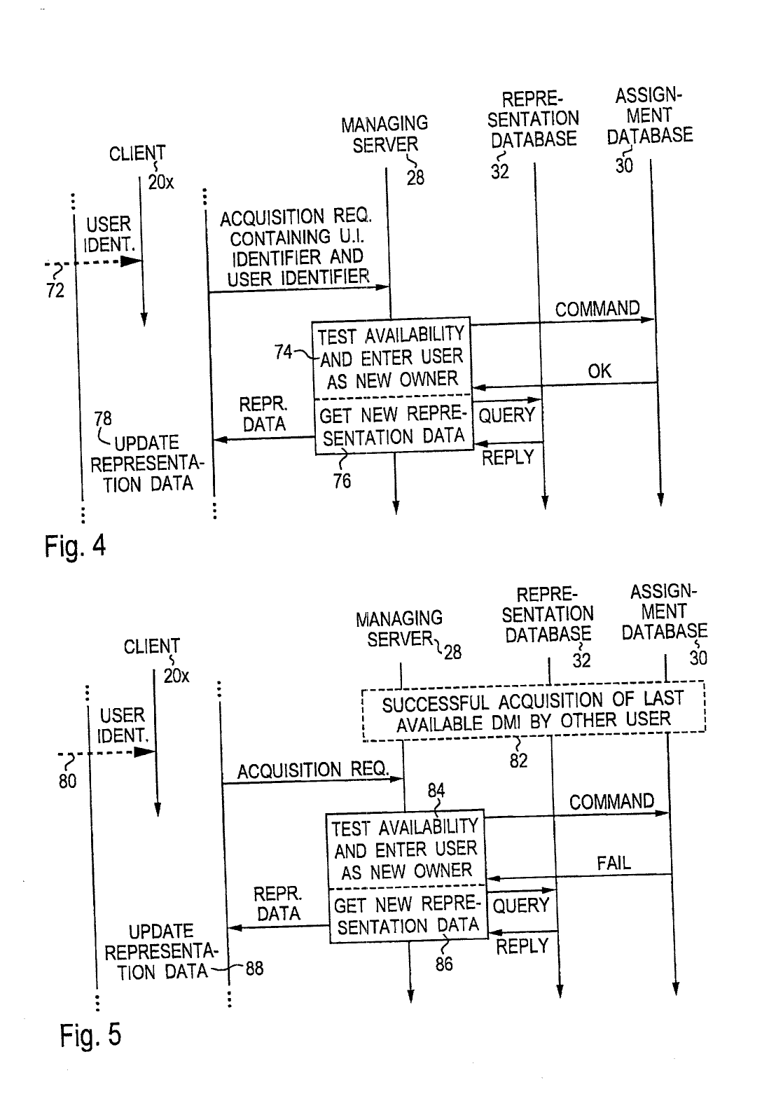

FIG. 4 represents, as a first possible continuation of FIG. 3, a sample execution sequence in which the user successfully acquires the digital marketing instrument,

FIG. 5 represents, as a second possible continuation of FIG. 3, a sample execution sequence in which the user fails to acquire the digital marketing instrument,

FIG. 6 represents, as a third possible continuation of FIG. 3, a sample execution sequence in which the user is informed that the digital marketing instrument is no longer available,

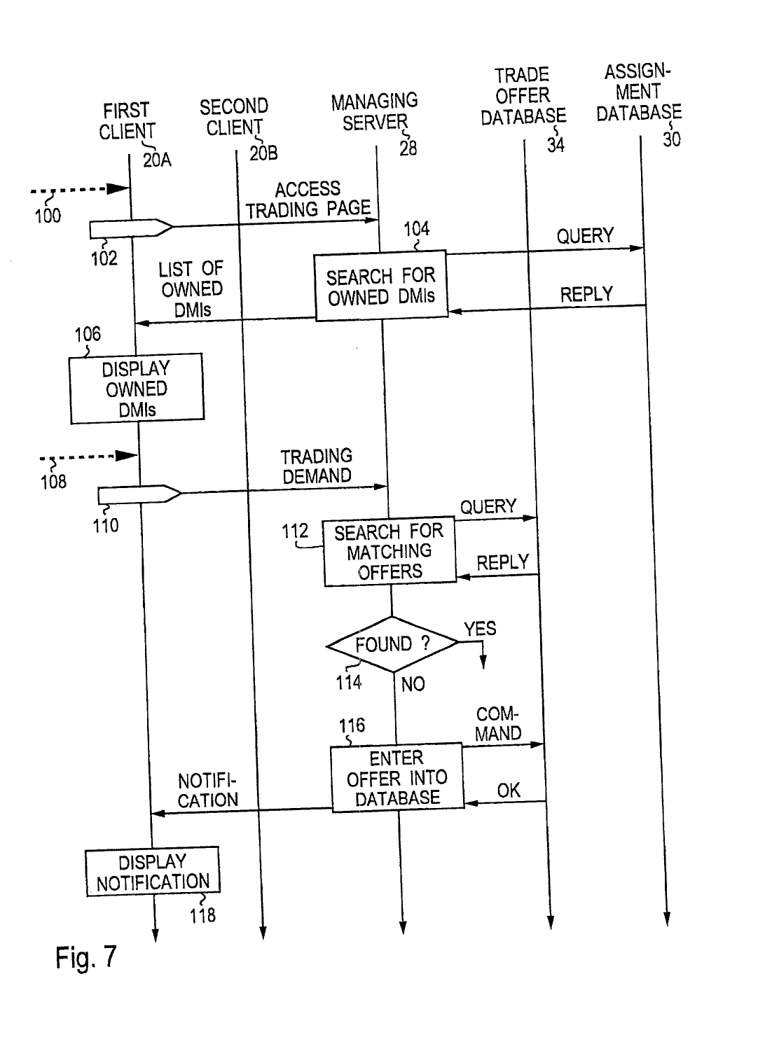

FIG. 7 is a sample execution sequence of a first user offering to trade a digital marketing instrument,

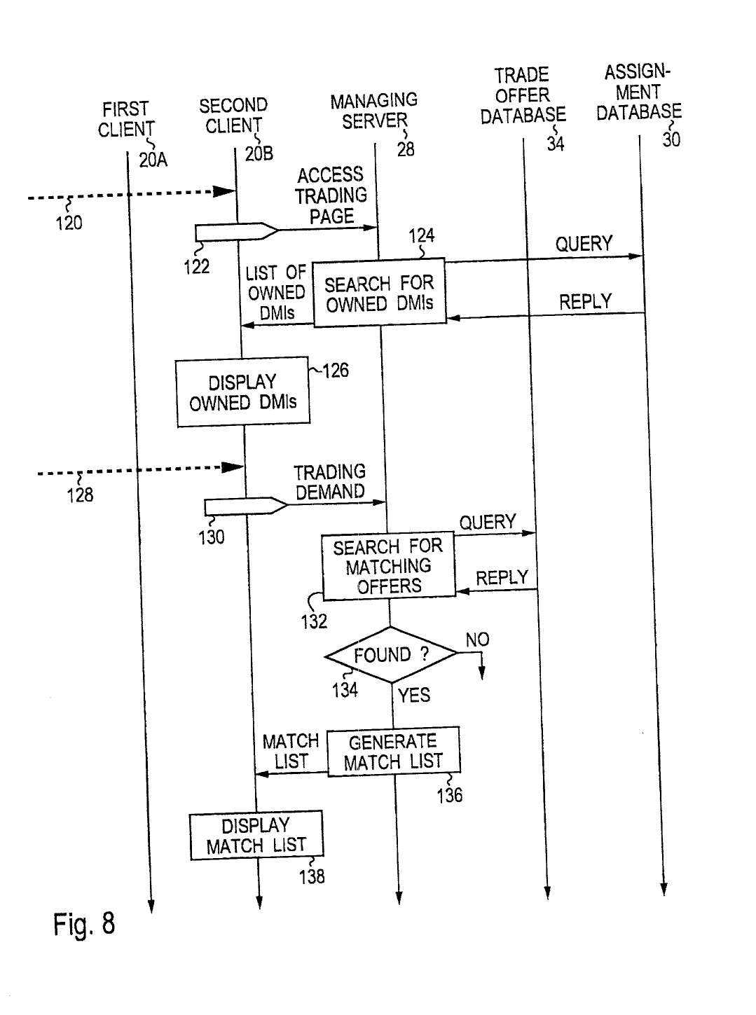

FIG. 8 is a continuation of the sample execution sequence of FIG. 7 in which a second user searches for available trading offers, and

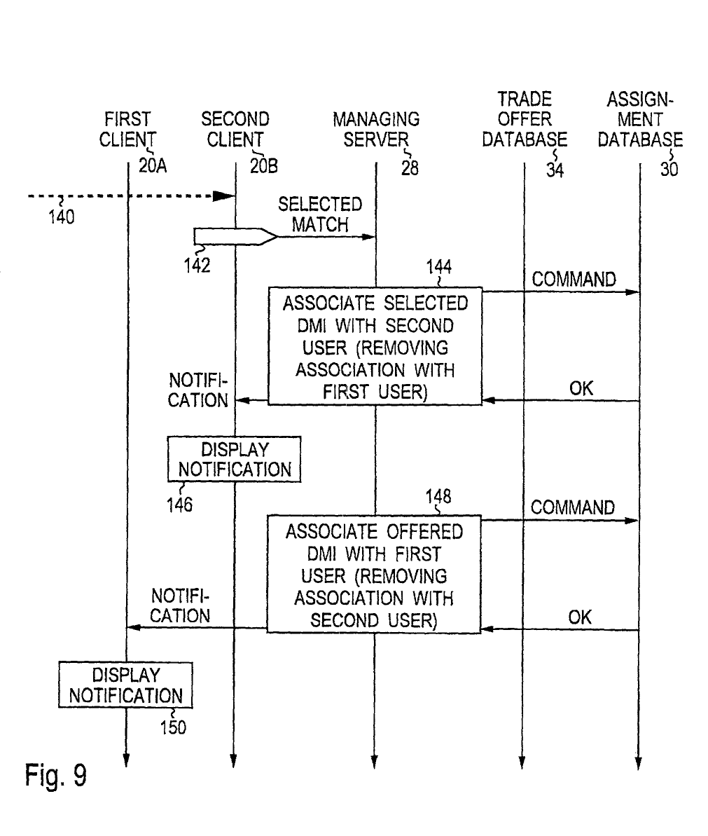

FIG. 9 is a continuation of the sample execution sequence of FIG. 7 and FIG. 8 in which ownership of the respective digital marketing instruments is exchanged between the first and the second user.

FIG. 1 represents a small fraction of a computer network 10 in the present sample embodiment, the computer network 10 comprises the Internet and other communication networks like university and commercial networks and wireless data transmission networks. A large number of devices are part of the computer network 10 and communicate which each other via a data communication arrangement 12, which may in turn comprise many computers, protocols and data transmission media. FIG. 1 depicts some sample devices of the computer network 10, which are relevant for the present invention. A plurality of commercial sites 14A, 14B, 14C (abbreviated as “14×”) each comprise a commercial server 16A, 16B, 16C (abbreviated as “16×”) and a commercial page repository 18A, 18B, 18C (abbreviated as “18×”).

A first client 20A and a second client 20B are shown in FIG. 1. These clients 20A, 20B (abbreviated as “20×”) belong to a first user and a second user of the system, respectively. The users may be possible consumers of the products and services offered at the commercial sites 14×, or they may be participants in an online game or in online discussion groups. It is of course desirable that as many users as possible take advantage of the possibilities provided by the present invention.

The clients 20× are well-known personal computers (PCs) having the usual interface elements like a video display, a keyboard, a mouse, and a modem for connection to the data communication arrangement 12. A standard Internet browser, like one of the browsers known under the trademarks Microsoft Internet Explorer and Netscape Navigator, runs on each of the clients 20×, and a corresponding browser window 22A, 22B (abbreviated as “22×”) is displayed on the respective video screens. Each of the browser windows 22× shows a web page coming from one of the commercial sites 14×. The web pages each contain a graphical representation 24A, 24B (abbreviated as “24×”) of a digital marketing instrument (DMI) according to the present invention.

A variety of devices other than the personal computers shown in FIG. 1 may be used to serve as clients 20×. This includes other Internet enabled devices like television settop boxes or webpads as well as mobile devices like WAP enabled telephones, UMTS devices and handheld devices connected to the data communication arrangement 12 via a Bluetooth™ link.

In the present sample embodiment, important administrative services are provided by a managing site 26. The managing site 26 comprises a managing server 28 communicating with the data communication arrangement 12 and with a plurality of databases. An assignment database 30 is used to record assignments of DMIs to individual users. The various possible representations of each DMI are stored as representation data in a representation database 32. Since the present sample embodiment also supports trading and exchange of DMIs between users, a trade offer database 34 is used to store all pending requests of users who are willing to trade DMIs currently in their possession for other DMIs. A statistics database 36 serves for recording all transactions in connection with the acquisition and trading of DMIs in order to obtain profiles of the interests and behavior of the individual user.

The various data repositories 30-36 have been shown in FIG. 1 as individual databases in order to increase the clarity of the present description. It is apparent that all these (and possibly further) databases may be processed by a single database management system and may be implemented in a number of ways, for example as tables in one large database. Likewise, the managing server 28 may be a single computer or a cluster of computers working together to provide the necessary management functions.

FIG. 2 shows how a DMI is implemented in the present sample embodiment. In the context of this sample embodiment, a DMI can be thought of as a virtual coupon or a virtual collecting or trading card. The implementation of each DMI provides a suitable (graphical, textual or audible) representation of the DMI to the user. Furthermore, the concept of ownership of a DMI is implemented by recording assignment data for each DMI that has been given out to a user in the assignment database 30.

In the example embodiment shown in FIG. 2, user interface code 38 is embedded in an access script 40 for implementing the DMI. The user interface code 38 controls the process of displaying the representation 24 of the DMI within the browser window 22×. The data used for providing the representation 24× comes from the managing site 26, more accurately from its representation database 32 (shown in FIG. 1). This is symbolized by a dashed arrow in FIG. 2.

The access script 40 further contains a family identifier 42, and the user interface code 38 contains a user interface identifier 44. The family identifier 42 specifies the marketing campaign and marketing message that should be conferred by the DMI. Comparing this with physical (printed) coupons, the family identifier 42 specifies the coupon series, wherein many actual coupons may be printed in one series. The user interface identifier 44 is employed to identify the DMI to the managing site 26 as long as the user interface code 38 is running.

The DMI shown in FIG. 2 only comprises a family identifier 42 that is not unique in the sense that many coupons with the same family identifier 42 may exist. A unique DMI identifier is present in alternative embodiments. This unique identifier may be created when a DMI is first assigned to a user, or it may be created when the DMI is prepared for distribution. By logical necessity, the unique identifier comprises the family information and shall therefore also be considered as a family identifier, but an extra family identifier may nevertheless be present for facilitating bookkeeping operations.

The example of FIG. 2 is that of a DMI whose representation is displayed by an Internet browser. Consequently, the access script 40 is written in a markup language (e.g., HTML code), and the user interface code 38 is a Java1™ Applet or a Macromedia™ Flash™ presentation, depending on whether or not a Java™ Virtual Machine and/or a Flash™ plug-in are available at the client's browser.

It is an important feature of the present sample embodiment that one and the same DMI can be represented at a wide variety of clients having different capabilities. For example, if the client is a WAP enabled mobile telephone, the access script 40 will be WML code, and the user interface code 38 will just contain WML tags that cause some plain ASCII text to be displayed. If the client is an Internet browser that does not support sophisticated multimedia formats, a static graphic will be shown for representing the DMI. In general, the “richest” user interface and the “richest” multimedia presentation possible will be used for any given client.

The initial steps of offering a DMI to a user for acquisition are shown in FIG. 3. The user begins this process in step 50 by entering, at the client 20×, the site name of a commercial site 14× that distributes DMIs. The client 20× accesses the distribution zone of the commercial site 14× in step 52. In the context of the presently described sample embodiment, distribution of DMIs takes place in the World Wide Web, and a distribution zone is an Internet web site. Alternatively, a distribution zone may also be a geographical region like a grocery store when mobile devices like Bluetooth™ units or mobile telephones or devices equipped with GPS units are used as clients 20×.

In step 54 of the present sample run, the commercial site 14× answers the request of the user by sending the requested web page to the client 20×. The web page is created by the company that runs the commercial site 14× and may include any content. For accessing the functionality of the present invention, the access script 40 (FIG. 2) is embedded in the web page at that location where the DMI is to be shown to the user. As mentioned above in connection with FIG. 2, the access script 40 is written in the JavaScript™ language and comprises the family identifier 42 specifying the family or series of the DMI that is to be shown to the user.

The client 20× then displays the received web page in its browser window 22× (step 56), and executes the access script 40 (FIG. 2) in step 58. As a result of this execution step 58, the family identifier 42 (FIG. 2) is passed to a servlet of the managing server 28.

In step 60 performed by the managing server 28, the servlet creates appropriate user interface code 38 that is forwarded to a client 20× and is executed in step 62.

The user interface identifier 44 contained in the user interface code 38 is chosen by the managing server 28 as a unique identifier that allows ongoing communication between the client 20× and the managing server 28. In the present sample execution sequence, the user interface code 38 is a Java™ applet or a Macromedia™ Flash™ presentation offering sophisticated presentation functions and in particular the possibility to access and display different representations of the DMI. Suitable representation data, which indicates that a DMI corresponding to the specified family identifier 42 is available for distribution, is obtained from the representation database 32 in step 64 and is sent to the client 20×. Under control of the running user interface code 38, the client 20× displays the received representation data in step 66. The corresponding representation 24× is thus shown to the user in the browser window 22× of the client 20×.

The user interface code 38 generated in step 60 is automatically adapted to the features offered by the client 20×. For example, if the client 20× is a WAP device or a simple Internet browser that neither has a Java™ virtual machine nor a Flash™ plug-in, the user interface code 38 will just consist of HTML or WML tags that cause the client 22× to access the appropriate representation data in the representation database 32. Such representation data may be a simple JPEG or GIF image or even plain ASCII text. It should be noted that the sample execution sequence of FIG. 3 is based on the assumption that the client 20× supports active program components in the user interface code 38 such that a “rich” user interface may be offered. For clients 20× with more limited capabilities, the execution sequences shown in the figures would have to be modified accordingly.

FIG. 3 further shows execution of a status check sequence which confirms that the displayed DMI is still available for acquisition. The status check process is started on a periodical basis by the user interface code 38 running on the client 20×. The status check is initiated by sending a status check request message containing the user interface identifier 44 to the managing server 28. In response to the request message, the managing server 28 queries the assignment database 30 whether or not the DMI displayed by the client 20× is still available for acquisition. It is assumed in the sample run of FIG. 3 that this is still the case, and consequently no change of the representation 24× is required.

It should be noted how the user interface identifier 44 allows an ongoing communication between the managing server 28 and each individual user interface executed by one of the clients 22×. Thus the functionality and appearance of a DMI may be updated whenever this is desirable from a marketing perspective. In consequence, the managing server 38 may synchronize all displayed DMIs at the various clients 20×, thus creating a whole wealth of possibilities for interaction between the users of these clients 20× in a user community.

Again, the possibility of performing regular status checks is contingent upon the client 20× having sufficient capabilities. For some rather simple Internet browsers, it might be possible to implement a corresponding feature by means of an automatic refresh capability of the browser. However, there will also be configurations in which no automatic status check is possible because of a lack of browser capabilities.

FIG. 4 to FIG. 6 show three alternative scenarios how the sample execution run of FIG. 3 may be continued. FIG. 4 is the case of the successful acquisition of the DMI whose representation 24× is displayed at the client 20× by the user of the client 20×. The user signals his or her desire to acquire the DMI (e.g., by clicking onto the representation 24×) and enters his or her user identifier in step 72. The user identifier has been assigned to the user when he or she registered for participation in the DMI acquisition and exchange system. The user interface that is created by the user interface code 38 running on the client 20× sends a corresponding acquisition request to the managing server 28. The acquisition request contains the user interface identifier 44 designating the particular user interface and the user identifier that has just been entered.

In embodiments using less sophisticated clients 20×, the acquisition process may be started by the user clicking onto an hyperlink that is contained in the representation 24 of the DMI and that contains the user interface identifier 44 encoded in the target address. The user may then be prompted to enter his or her user identifier.

Upon receipt of the acquisition request, the managing server 28 issues a command to the assignment database 30 to test whether or not the desired DMI is still available. If this is the case, the user is entered as the new owner of the DMI in the assignment database 30, and the managing server receives a success message of the assignment database 30. According to well-known practice in database management systems, the test and update operation is considered as an atomic action such that no changes to the relevant records of the assignment database 30 are permitted during the test and update operation.

Several possibilities are contemplated for the organization of the assignment database 30. For example, each family identifier of a DMI may be associated with a list of all users that own one of the DMIs from the family (the number of owners is limited by the number of DMIs contained in the family). It is also possible to associate each user identifier with a list of all DMIs (family identifier or unique identifier) owned by this user. Furthermore, a one-to-one association of unique DMI identifiers (e.g., user interface identifiers) with user identifiers is also possible.

The successful completion of step 74 is indicated to the user by updating the representation data. For this purpose, the managing server 28 obtains new representation data from the representation database 32 and sends it to the client 20× (step 76). There, the new representation data is displayed in step 78. The new representation data may, for example, be a video sequence showing that the DMI is taken by the user, or it may be the original representation with the additional lettering “You got it!”.

The execution sequence of FIG. 5 corresponds to that of FIG. 4 with the difference that the acquisition process is unsuccessful. Again, the user enters his or her user identifier in step 80, and a corresponding acquisition request is sent by the client 20× to the managing server 28. The difference to the execution run of FIG. 4 is that in FIG. 5 the last available DMI of the DMI family has just been acquired by another user in step 82. This has the consequence that the availability test in step 84 fails. This failure is shown to the user by obtaining appropriate new representation data 86 from the representation database 32 in step 86, transmitting this representation data to the client 20× and displaying it to the user in step 88. For example, the new representation data may contain the words “Sorry, already taken”.

It has been mentioned above in connection with FIG. 3 that regular status checks are performed while the user interface is active and the DMI is displayed at the client 20×. As long as the status checks indicate that the DMI is still available, the representation 24× is not changed (steps 68 and 70 in FIG. 3). FIG. 6 shows a sample execution sequence of a status check resulting in a change of the displayed representation 24×.

It is supposed that the last available DMI of the family displayed to the user has just been acquired by another user in step 90. Shortly thereafter, the client 20× initiates a status check in step 92. A status check request containing the current user interface identifier 44 is sent to the managing server 28. Consequently, the managing server 28 queries the assignment database 30 for the availability status of DMIs belonging to the corresponding family. The assignment database 30 reports the fact that no further DMIs are available for this family. In order to show this status change to the user, the managing server 28 obtains suitable new representation data from the representation database 32 in step 96. The new representation data is transmitted to the client 20× and is displayed to the user in step 98. For example, the new representation 24× may comprise the words “Sorry, no longer available”. In alternative embodiments, the representation of the DMI may vanish altogether, or a DMI belonging to another family, in which the user might also be interested, may be shown.

This completes the description of the acquisition phase of DMIs. It should be noted that the managing server 28 records all accesses to DMIs and all successful acquisitions and unsuccessful acquisition attempts in the statistics database 36 to gather valuable information about the behavior and interests of the individual users and user communities and about the impact of different marketing schemes and DMI families.

The present sample embodiment also allows DMIs to be exchanged or traded between participating users. This feature is essential to make online card games possible, and it is also very important for inciting user interaction (thus making community-driven marketing possible) and for improving the quality of the collected behavioral data.

A sample execution sequence of a complete trading process is depicted in FIG. 7 to FIG. 9. The first portion, shown in FIG. 7, is that of a first user situated at the first client 20A selecting a DMI for trading and issuing an (unsuccessful) trading demand. The process starts in step 100 when the first user instructs the browser running at his or her client 20A to access the first user's trading page (step 102). The user-specific trading page is part of a large trading area maintained by the managing server 28. The command issued by the first user may consist of a URL (stored, for example, in a bookmark) that contains the address of the first user's individual trading area in encoded form. Alternatively, the first user may access the general trading area and may there be prompted for his or her user identifier. It is also possible that the user identifier is stored in a cookie at the first client 20A and is automatically sent to the managing server 28 in step 102.

Each user-specific trading page contains a variety of information items tailored to the presumed interests of the user, and in particular a list or graphical representation of all DMIs owned by this user. When the first user's trading page is accessed in step 102, the managing server 28 determines the owned DMIs by sending a corresponding query to the assignment database 30 (step 104). The reply of the assignment database 30 is used by the managing server 28 for creating a suitable reply to the request of the first client 20A. This reply enables the first client 20A to display the first user's trading page containing all DMIs owned by the first user (step 106).

A straightforward implementation of the display functionality described in the previous paragraph would be that the managing server 28 processes the reply of the assignment database 30 and generates a complete markup language page in step 104, which is sent to the browser executed by the first client 20A and is displayed in step 106. This markup language page could contain a list or table of the owned DMIs, wherein each DMI may be represented by a textual description or by a small (thumbnail) picture or by a full-featured graphic or multimedia representation taken from the representation database 32.

In the present sample embodiment, however, a more sophisticated scheme is used for displaying the available DMIs to the first user in step 106. For each DMI, a suitable access script 40 (FIG. 2) is generated by the managing server 28, and all such access scripts are transmitted to the first client 20A as the result of step 104. As described above in connection with FIG. 3, each access script 40 contains user interface code 38, a family identifier 42 and a user identifier 44. The access script 40 or the identifiers contained therein are suitably modified to designate that the identified DMI shall not be acquired, but is already owned. When the access scripts 40 have been transferred to the first client 20A, their respective user interface code 38 is executed, and appropriate representation data is obtained from the representation database 32 and is displayed in the browser window 22A of the first client 20A. This approach has the advantage that essentially the same user interface code 38 can be used in connection with both the acquisition and the exchange of DMIs, thus minimizing the development costs for the overall system (the user interface code 38 may be rather complex since it should be able to cope with a large variety of different browser configurations and DMI representations).

When the available DMIs have been displayed in step 106, the first user indicates in step 108 which of these DMIs he or she is willing to offer. This indication may be a simple click onto the displayed representation of the DMI. Optionally, the first user may also enter his or her preferences regarding the DMI to be obtained by the trade. For example, the first user may enter a company name or a product name or some other information as a search term in a field of the trading page, or the first user may select one or more categories, or the first user may accept a proposal made by the managing server 28 on the basis of the first user's previous behavior. The information regarding the offered DMI and, if applicable, any information regarding the user's trading preferences is sent to the managing server 28 in the form of a trading demand (step 110).

The managing server 28, upon receipt of the trading demand, queries the trade offer database 34 for a corresponding trade offer that has been entered earlier by another user (step 112). A “corresponding” trade offer is one that matches the trading demand both with respect to the DMI offered by the first user (if the other user has specified any particulars with respect to the DMI he or she would like to receive) and with respect to the DMI offered by the other user (if the first user specified any preferences in his or her trading demand). It is assumed in the present sample run that no suitable offer is found (“no” branch of test 114). The trading demand is therefore entered into the trade offer database 34 in step 116, and a suitable notification is sent to the first client 20A and is displayed to the first user in step 118.

The exchange process continues in FIG. 8 by a second user situated at the second client 20B offering one of his or her DMIs for trade. Steps 120 to 132 in FIG. 8 exactly correspond to steps 100 to 112 in FIG. 7, and reference is made to the above text for a detailed description of these steps. It is now assumed that the trading demand of the second user corresponds to that of the first user stored in the trade offer database 34 in step 116. In particular, this means that the second user is willing to accept the DMI offered by the first user and vice versa. The first user's trading demand is therefore found in the database search in step 132 as a matching offer, and execution continues with the “yes” branch of test 134.

The managing server 28 generates a list of all matching trading offers (among them, the trading offer of the first user) in step 136. This information is transmitted to the second client 20B at the end of step 136, and it is displayed in step 138. It should be noted that the match list is just a collection of DMIs available for trade. Therefore the same techniques as described above in connection with the displaying of available DMIs (steps 104 and 106 in FIG. 7) are used for displaying the matching trade offers in step 138. It is possible in some embodiments that the owned DMIs of the second user (result of step 124) and the DMIs available for trade (result of step 136) are displayed simultaneously in two portions of the browser window 22B.

The DMI exchange process continues as shown in FIG. 9. The second user selects one of the possible trade offers in step 140. This selection step may simply be that the second user clicks onto the graphical representation of the chosen DMI, which is still shown in the browser window 22B as a result of step 138. The information concerning the selected matching DMI is sent to the managing server 28 in step 142.

The following steps concern the actual change of ownership of the DMIs. In step 144, the managing server 28 issues a database command to the assignment database 30 that the second user shall be recorded as the owner of the DMI selected in step 140. After successful completion of the database modification concerning the selected DMI in step 144, a notification message is sent to the second client 20B. The notification is displayed to the second user in step 146.

It is assumed in the present sample embodiment that the database write command of step 144 at the same time causes the former ownership relation between the first user and the selected DMI to be removed. For example, this is the case in implementations where the assignment database 30 comprises a table linking unique DMI identifiers (e.g., the user interface identifier used in the acquisition of a DMI) with the user identifier of the present owner. Entry of a new user identifier into this table will at the same time associate the DMI with the new owner and remove the former association of the DMI with the former owner. In other implementations, e.g., in implementations where the assignment database 30 contains a list of the owned DMIs for each user identifier, this automatism does not exist. Two different sub-steps are necessary for completing step 144 in these implementations, i.e., a first sub-step in which the selected DMI is deleted from the list of DMIs owned by the first user, and a second sub-step in which the selected DMI is added to the list of DMIs owned by the second user.

Similarly to the above step 144, the change of ownership of the DMI offered by the second user is recorded in the assignment database 30 in step 148. The first user is entered as the owner of the offered DMI, and the ownership relation with the second user is removed either automatically or in a separate sub-step. Notification regarding the successful transaction is sent to the first client 20A and is displayed in step 150. Because of the request/reply nature of the Internet HTTP protocol, this notification in step 150 may require that regular status checks or page reload commands are generated (or are manually entered by the first user) at the first client 20A. Such regular status checks may be initiated by the user interfaces executed by the client 20A, as described below.

It will normally be desirable in connection with pending trading demands to automatically update the lists of owned DMIs, which are displayed in steps 106 and 126, on a regular basis. Depending on how these displaying steps are implemented, new markup pages containing representations of the owned DMIs may have to be generated and sent to the respective clients 20×. In the present sample embodiment, however, each representation of an owned DMI is controlled by its own user interface code 38 performing periodic status checks (as shown in FIG. 6). The owned DMI display will therefore automatically adapt to any changes of ownership recorded in the assignment database 30.

These regular status checks can also be used to query the managing server 28 with respect to the occurrence of any changes of ownership. No explicit notification is necessary if it is assumed that spontaneous changes of ownership can only result from successful completion of a pending trading demand. For example, if ownership of a particular DMI is suddenly lost, the DMI representation with the text overlay “You just gave me away!” may be shown for some time before the representation vanishes altogether. Conversely, the representation of any new DMI obtained by trading may be marked with the message “You just got me!” for some time.

In some embodiments, a trading process is shown to the user by a changing graphical representation 24× of one and the same running user interface. This implementation has the advantage that the number of running user interfaces for each client 20× does not change during trading, such that it is not necessary to provide ways of stopping the execution of user interfaces or starting further user interfaces during a trading session.

During all steps of the trading process described above, the managing server 28 records suitable information about all completed trading transactions and about all trading offers for obtaining in-depth data about the interests and preferences of individual users and user communities. This information is further processed and combined with the information gathered in the acquisition process. The resulting user profiles are stored in the statistics database 36.

It can thus be seen that the invention can be used for supporting community-driven marketing schemes in a variety of ways. The particulars contained in the above description of sample embodiments should not be construed as limitations of the scope of the invention, but rather as exemplifications of preferred embodiments thereof. Many other variations are possible and will be readily apparent to persons skilled in the art. Accordingly, the scope of the invention should be determined not by the embodiments illustrated, but by the appended claims and their legal equivalents.

We claim:

1. A method for assigning a digital marketing instrument to a user in a computer network, said computer network comprising a managing server accessing an assignment database and a client communicating with said managing server, said digital marketing instrument originally not being assigned to said user in said assignment database, said method comprising the steps of:
displaying a representation of said digital marketing instrument at said client,
recording the assignment of said digital marketing instrument to said user in said assignment database, and
updating the displayed representation of said digital marketing instrument to reflect the new assignment status of said digital marketing instrument.

2. The method of claim 1,
wherein said step of recording said assignment is initiated by an acquisition request coming from a further client that is different from the client that performs said displaying and updating steps.

3. The method of claim 1,
wherein said representation is displayed and updated under control of a user interface, said user interface being provided by user interface code executed by said client.

4. The method of claim 3,
wherein said user interface automatically initiates status checks in which the assignment database is queried to detect any change of the assignment status of said digital marketing instrument.

5. The method of claim 4,
wherein said client communicates with said managing server using a request/reply protocol, and wherein said status checks are initiated by said user interface by sending a status check request to said managing server on a regular basis.

6. The method of claim 5,
wherein said user interface comprises a user interface identifier that serves for identifying said user interface in said status check requests.

7. The method of claim 1,
wherein said displaying step comprises the step of transmitting an access script from said managing server to said client, said access script comprising an identifier that at least specifies the family of said digital marketing instrument.

8. The method of claim 1,
wherein said digital marketing instrument is a virtual coupon.

9. The method of claim 1,
wherein said digital marketing instrument represents at least one of a commercial value and an exchange value and an aesthetic value and a social recognition value and a collector's value.

10. A digital marketing instrument that is adapted to be assigned to a user in a computer network, said computer network comprising a managing server accessing an assignment database and a client communicating with said managing server, said digital marketing instrument originally not being assigned to said user in said assignment database, wherein, when the digital marketing instrument is assigned to said user in said computer network:
a representation of said digital marketing instrument is displayed at said client,
the assignment of said digital marketing instrument to said user is recorded in said assignment database, and
the displayed representation of said digital marketing instrument is updated to reflect the new assignment status of said digital marketing instrument.

11. The digital marketing instrument of claim 10,
wherein said assignment of said digital marketing instrument is initiated by an acquisition request coming from a further client that is different from the client that displays said representation of said digital marketing instrument and updates said displayed representation.

12. The digital marketing instrument of claim 10,
wherein said representation is displayed and updated under control of a user interface, said user interface being provided by user interface code executed by said client.

13. The digital marketing instrument of claim 12,
wherein said user interface automatically initiates status checks in which the assignment database is queried to detect any change of the assignment status of said digital marketing instrument.

14. The digital marketing instrument of claim 13,
wherein said client communicates with said managing server using a request/reply protocol, and wherein said status checks are initiated by said user interface by sending a status check request to said managing server on a regular basis.

15. The digital marketing instrument of claim 14,
wherein said user interface comprises a user interface identifier that serves for identifying said user interface in said status check requests.

16. The digital marketing instrument of claim 10,
wherein, before said representation of said digital marketing instrument is displayed at said client, an access script is transmitted from said managing server to said client, said access script comprising an identifier that at least specifies the family of said digital marketing instrument.

17. The digital marketing instrument of claim 10,
wherein said digital marketing instrument is a virtual coupon.

18. The digital marketing instrument of claim 10,
wherein said digital marketing instrument represents at least one of a commercial value and an exchange value and an aesthetic value and a social recognition value and a collector's value.

19. An apparatus for assigning a digital marketing instrument to a user in a computer network, said apparatus comprising a managing server accessing an assignment database, said computer network comprising said apparatus and a client communicating with said managing server, said digital marketing instrument originally not being assigned to said user in said assignment database, said apparatus being adapted for:
causing a representation of said digital marketing instrument to be displayed at said client,
recording the assignment of said digital marketing instrument to said user in said assignment database, and
causing the displayed representation of said digital marketing instrument to be updated to reflect the new assignment status of said digital marketing instrument.

20. The apparatus of claim 19,
wherein said assignment of said digital marketing instrument is initiated by an acquisition request coming from a further client that is different from the client that displays said representation of said digital marketing instrument and updates said displayed representation.

21. The apparatus of claim 19,
wherein said representation is displayed and updated under control of a user interface, said user interface being provided by user interface code, said user interface code being provided by said apparatus to said client.

22. The apparatus of claim 21,
wherein said user interface automatically initiates status checks in which the assignment database is queried to detect any change of the assignment status of said digital marketing instrument.

23. The apparatus of claim 22,
wherein said client communicates with said managing server using a request/reply protocol, and wherein said status checks are initiated by said user interface by sending a status check request to said managing server on a regular basis.

24. The apparatus of claim 23,
wherein said user interface comprises a user interface identifier that serves for identifying said user interface in said status check requests.

25. The apparatus of claim 19,
wherein, before said representation of said digital marketing instrument is displayed at said client, an access script is transmitted from said managing server to said client, said access script comprising an identifier that at least specifies the family of said digital marketing instrument.

26. The apparatus of claim 19,
wherein said digital marketing instrument is a virtual coupon.

27. The apparatus of claim 19,
wherein said digital marketing instrument represents at least one of a commercial value and an exchange value and an aesthetic value and a social recognition value and a collector's value.
